(19) United States
(12) Patent Application Publication
(10) Pub. No.: US 2025/0106492 A1
(43) Pub. Date: Mar. 27, 2025

(54) A CAMERA, A SYSTEM FOR DETECTING AN OPTICAL IDENTITY TAG AND A METHOD FOR IDENTIFICATION

(71) Applicant: SECURE IMAGE FEED OY, Eura (FI)

(72) Inventor: Jukka JÄRVINEN, Kokemäki (FI)

(21) Appl. No.: 18/833,941

(22) PCT Filed: Feb. 5, 2023
(86) PCT No.: PCT/FI2023/050071

§ 371 Date: Jul. 29, 2024

(30) Foreign Application Priority Data
Feb. 5, 2022 (FI) 20225103

(51) Int. Cl. H04N 23/55; G06K 7/14; G06K 19/06; G06T 1/00

(52) U.S. Cl. CPC H04N 23/55; G06K 7/1417; G06K 19/06037; G06K 19/06065; G06T 1/0021

(57) ABSTRACT

A camera (10), a system and a method for identification utilize an identification marker arranged inside the camera, at a cover glass (15) for the image sensor (14). The system comprises the camera and an optical identity tag (31) placed outside the camera (10). The optical identity tag (31) comprises a security hologram configured to reflect rays of light in a first predefined light pattern (71); the cover glass (15) comprises an identification marker (1) at the optical path, wherein the identification marker (1) is configured to block rays of light to reach a portion of the image sensor (14); and the identification marker (1) is configured to alter the first predefined light pattern (71) into a second predefined light pattern (72), when the first predefined light pattern (71) is reflected from the optical identity tag (31) to the identification marker (1).

### BACKGROUND

Digital imaging is prone to editing, filtering or even forgery. The recipient of the digital image or video may not fully trust the content or its authenticity. Backgrounds may be changed for a video conference; participant's faces may be enhanced or even changed. In one example, deepfakes are synthetic videos or images, where existing image or video is replaced with someone else's likeness. As the deepfake technology advances, it becomes increasingly difficult to tell apart real content and fake content. Whatever the camera has captured, may be later altered.

Participants of video conferences are currently trusted by very simple methods. As one example, during the opening procedures of video conferences at the European Patent Office, the participants are recognized by showing their identity cards or passports to the camera. It is obvious that such documents may not be verified, as forged documents would have similar appearance.

The real world objects in photographs are difficult to verify. Various technologies have been introduced to mitigate the problem. The object may have an embedded RFID tag, NFC tag or a QR code that may be certified as part of its digital image. The camera may add metadata of the object into the image data. The digital image may be watermarked, or digital signatures may be embedded into the image data to ensure its authenticity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A camera, a system for detecting an optical identity and a method for identification are disclosed hereinafter. The camera has an additional identification marker that provides a mark to each image or video captured with the camera. The camera is in one example a complete module suitable for smartphones, laptops or tablet computers. The camera has a lens configured to focus rays of light onto an image sensor. On top of the image sensor, at a small distance, is a cover glass that may comprise an infrared filter.

The cover glass comprises a physical identification marker that blocks rays of light so that they cannot travel to a portion of the image sensor. In one example the identification marker casts a shadow on the image sensor, of the light traveling from the lens. When the image sensor has captured an image, the identification marker or its visual pattern is visible in the image.

Human eye may detect similar entoptic phenomenon during an ophthalmologic examination. This phenomenon, called Purkinje tree is an image of the retinal blood vessels in one's own eye. When a beam of small bright light shines through the pupil from the periphery of a subject's vision, the position of light is not normal to human, so the abnormal light position casts shadows of the blood vessels onto unadapted portions of the retina. Normally, human brain has been adapted to compensate the blood vessels from the vision. In this rare situation the shadows become visible. Therefore, human eye is reactive to shadows in the vicinity of the retinal cells.

The identification marker may provide multiple optical effects to the image sensor. The identification marker may comprise at least partially a polarizing filter that filters, for example, reflection from a surface. The identification marker may comprise a grating that produces a diffraction effect to the image sensor. The identification marker may apply techniques such as holography, optically variable device (OVD) or diffractive optically variable image device (DOVID).

The system for detecting the optical identity tag is based on the mutual effect of the identification marker and the external optical identity tag. Examples of the optical identity tag are security holograms that may be attached or embedded to labels, quality products or to security items such as passports, credit cards or banknotes. Holograms are very difficult to forge because they are replicated from a master hologram which requires expensive, specialized and technologically advanced equipment.

The optical effect of the optical identity tag interacts with the identification marker placed inside the camera to provide another image. The optical identity tag reflects a first predefined light pattern that is further filtered or altered by the identification marker to produce a second predefined light pattern.

The method comprises a step of marking an image captured by the camera by a pattern caused by the identification marker to the image sensor. The pattern caused by the identification marker may be used to verify the image and the physical camera used to provide the image. For example, during the starting moments of a video conference session either party may verify from the image or video feed that the image contains the pattern caused by the identification marker. The pattern may be enhanced by applying external light directly to the camera, for example pointing a smartphone flashlight temporarily onto the laptop camera containing the identification marker. As the camera itself is verified, the next steps of verifying the content of the video feed become easier. The short distance between the cover glass and the image sensor may cause slight variation in the pixels affected by the pattern. For example, moving the flashlight may be required to cause variation to image to further verify the video stream. The image sensor typically has millions of pixels, therefore it is possible to detect the variation at the small area. Detecting this variation may be used to verify the image sensor and the camera.

The method comprises also altering, by the identification marker, the first predefined light pattern into the second predefined light pattern. The mobile camera may be used to detect real-world objects and verify those in a digital domain. The image recognition may utilize both the first predefined light pattern and the second predefined light pattern to verify the optical identity tag.

The physical image modification applied near the image sensor, by the identification marker allows various security solutions and verification methods that may be used in conjunction with traditional verification and/or authentication methods. As one example, face recognition systems may be applied to further increase the reliability of the authentication. The hardware used in the video conference may be verified to increase validity of other methods. Video conferences may become increasingly reliable, as both parties may verify their true identities.

The identification marker provides a visual marker to each image or video stream. Camera forensics may be used to verify each image as authentic and specify the device that has taken the image or video. The identification marker may be used as a further tool with the camera forensics. The visual marker may change according of various lighting conditions or lighting directions, thus making counterfeiting more difficult.

Many of the attendant features will be more readily appreciated as they become better understood by reference to the following detailed description considered in connection with the accompanying drawings. The embodiments described below are not limited to implementations which solve any or all the disadvantages of identification systems or methods, or any image marking solutions.

### BRIEF DESCRIPTION OF THE DRAWINGS

The present description will be better understood from the following detailed description read in light of the accompanying drawings, wherein

FIG. 1 illustrates schematically one exemplary embodiment of a camera;

FIG. 2 illustrates schematically a detail view of a first image sensor assembly;

FIG. 3 illustrates schematically a detail view of a second image sensor assembly;

FIG. 4 illustrates schematically one exemplary view of a video stream captured by the camera having an identification marker;

FIG. 5 illustrates schematically one exemplary scenario of applying the identification marker to the image captured by the camera;

FIG. 6 illustrates schematically one exemplary scenario of a system for detecting an optical identity;

FIG. 7 illustrates schematically one exemplary concept of modifying the optical identity by the identification marker;

FIG. 8a illustrates a flowchart of one aspect of a method identification; and

FIG. 8b illustrates a continuing flowchart of the method for identification.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present example may be constructed or utilized. However, the same or equivalent functions and sequences may be accomplished by different examples.

Although the present examples are described and illustrated herein as being implemented in identifying a session, a person or a product, these are provided as an example and not a limitation. As those skilled in the art will appreciate, the present examples are suitable for application in a variety of authentication, verification or identification by a variety of devices, systems or methods.

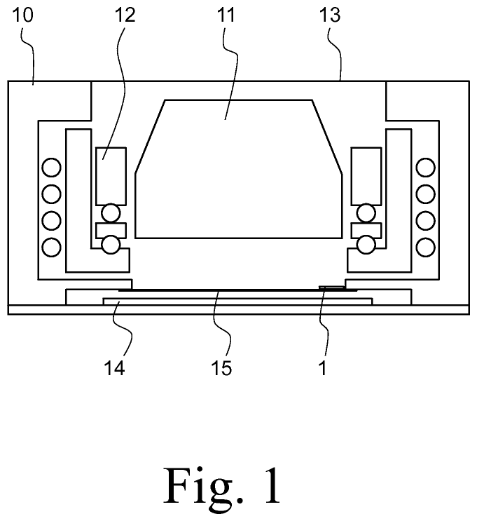

FIG. 1 illustrates schematically one exemplary embodiment of a camera 10. The camera 10 comprises a lens 11, for example a movable lens group or a lens module. The lens 11 may be movable inside the lens module itself, and/or by a frame 12 configured to suspend the lens 11 or the lens group module. The frame 12 may be used to provide optical image stabilization. An image sensor 14 is configured to receive light from the lens 11. An optical path is defined as a trajectory that a ray of light follows as it propagates through the camera 10. The camera 10 may comprise a transparent, protective glass 13 that protects the optics and/or the camera 10 as a whole.

A cover glass 15 for the image sensor 14 resides on the optical path between the lens 11 and the image sensor 14. The cover glass 15 provides cover for the image sensor 14, as dust particles, dirt or fluids could damage the vulnerable image sensor 14. In some embodiments, the cover glass 15 comprises an infrared filter that improves the perceived colours captured by the image sensor 14. Distance between the image sensor 14 and the cover glass 15 may be fractions of a millimetre or few millimetres. The cover glass 15 thickness may be selected to comply with the camera system, image sensor 14 size and the desired optical characteristics to be between few micrometres to several millimetres.

Examples of the camera 10 may be implemented to devices such as laptop computers, tablet computers, smartphones or dedicated compact cameras or video conference cameras. The device may comprise multiple cameras 10 at one side or different sides of the device, wherein the identification marker 1 may be implemented to one camera 10, to multiple cameras 10 or all cameras 10.

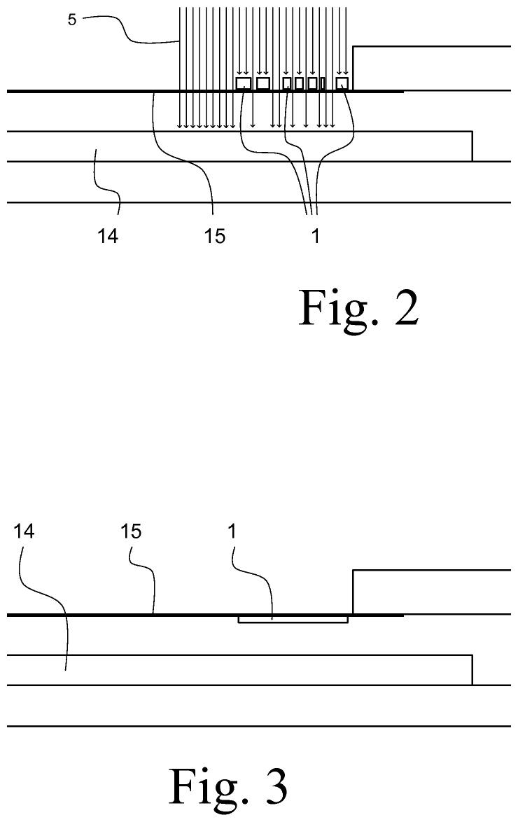

The cover glass 15 comprises an identification marker 1 at the optical path, between the lens 11 and the image sensor 14. The identification marker 1 is configured to block rays of light from reaching a portion of the image sensor 14. In one embodiment, the identification marker is configured to deflect rays of light. The identification marker 1 is configured to affect the travel of rays of light to the image sensor 14. In one embodiment, the identification marker 1 is configured to cast a shadow image of the identification marker 1 to the image sensor 14. FIG. 2 illustrates schematically a detail view of one exemplary embodiment of the identification marker 1, on top of the cover glass 15.

The identification marker 1 provides a pattern, a visual marking to each image captured by the camera 10 at a sufficient light. The visual marking is embedded in the original image data captured by the image sensor 14. The visual marking may be detectable from raw image file data. The identification marker 1 provides a physical watermark, in the form of the visual marking, to digital images or video streams. The visual marking may be selected according to the intended use of the camera.

The visual marking in the image may be used as one part of evidence in camera forensics, where authenticity of the image, or the source of the image is being examined. Other exemplary means for the camera forensics are examining dead pixels or lens imperfections. One example of defining the authenticity of the image is verifying the camera that has captured the image or the video.

The identification marker 1 is in one embodiment embedded inside the camera 10, which may be sealed and tamper-proof to indicate any attempts to modify the identification marker 1. In the example of FIG. 3 the identification marker 1 is placed to the side of the cover glass 15 facing the image sensor 14. The cover glass 15 may be brittle, thin, and difficult to remove intact. The identification marker 1 provides a security device to the camera 10, wherein each image carries the visual marking. The identification marker 1 may contain unique identifier that is stored to a database. The database may contain information of the cover glass 15 manufacturing and its installation into the camera 10. The manufacturing process and/or logistics between different manufacturing locations of the identification marker 1, cover glass 15 and the camera 10 may comply with appropriate security standards.

In one embodiment, the identification marker 1 comprises a grating. The grating comprises elongated, parallel elements that leave slots in between, allowing rays of light to travel through. The grating may comprise security hologram technology. In one embodiment, the grating is configured to produce a spectra by diffraction to the image sensor 14. In one embodiment, the grating is used to produce diffraction to the rays of light reaching the image sensor 14. In one embodiment, the grating provides various visual images that change according to the lighting conditions. In one embodiment, the grating provides an interference pattern to the image sensor 14. In one embodiment, the identification marker 1 comprises a point grating, causing a sinusoidal zone plate image onto the image sensor 14.

In one embodiment, security hologram technologies are applied to provide the identification marker 1 to the cover glass 15. In one embodiment, the identification marker 1 comprises a sticker attached to the cover glass 15. The sticker may be partially transparent to allow rays of light to travel through the sticker to the image sensor 14. In one embodiment, the sticker may comprise gratings, slots, holes or other physical openings to allow rays of light to travel through the sticker to the image sensor 14.

In one embodiment, identification marker 1 is printed directly on the cover glass 15 by an ink. In one embodiment, the ink is opaque. In one embodiment, the ink is partially transparent. In one embodiment, the ink comprises optical characteristics, such as an refractive index configured to allow rays of light to travel through the ink, and refract, to provide an optical effect to the image sensor 14. In one exemplary embodiment, the linewidth of the ink is 50 nm and the height of the ink on the cover glass 15 is between 70 . . . 200 nm. The small scale of the ink allows producing holographic effects, diffraction and/or refraction.

In one embodiment, the identification marker 1 comprises an etching of the cover glass 15. The etching may be produced by a laser. In one embodiment, the laser provides linewidth of 10 μm. The etching may be used to produce holographic effects, diffraction and/or refraction. In one embodiment, the etching is provided by an electron beam technology that may provide even smaller linewidths.

In one embodiment, the identification marker 1 comprises a coating on a portion of the cover glass 15, wherein portions of the coating have been removed to provide the image of the identification marker 1. In one embodiment, the coating is an electron beam resist that is known to have good adhesion to glass. In one embodiment, the coating is opaque to the light intensity applicable for normal camera exposures.

In one embodiment, the coating is further manipulated to achieve sufficient opaqueness. In one example, the electron beam resist is an electron-sensitive polymer that is heated to ensure adhesion to the cover glass 15 or to a larger sheet of glass. The coating is at least partially removed to provide a unique marking to the glass. The coating is in one embodiment removed by an electron beam lithography device and/or an electron beam pattern generator. In one embodiment, the coating is removed by a laser.

The marked coating is developed with a liquid compound and subjected to vaporized copper to provide sufficient opaqueness. The cover glass 15 or the larger sheet of glass are subjected to a lift-off process, wherein it is soaked in acetone or other suitable solvent to remove portions not having copper coating, leaving precise copper-coated markings on the cover glass 15 or on the larger sheet of glass. If the substrate glass being used is the larger sheet of glass, it may be cut to multiple individual cover glasses 15.

The manufacturing process for the cover glass may be reel-to-reel, reel-to-wafer, tape-and-reel or any other process, where the cover glass templates are fed to a manipulation phase where they receive individual markings. The cover glass template is manipulated by a selected method to receive the identification marker 1. The manipulation phase may comprise fiber lasers, wherein the coating or the glass itself is processed. In one exemplary embodiment, the fiber laser comprises six separate lasers split from one laser source, each configured to apply a directional cut to the cover glass 15 or to the coating. Each of the six laser provides only one direction, wherein the final identification marker 1 may require application from six directions. The laser may cut a bevel or a straight line to the glass surface. Alternatively, or in addition, the laser may create a notch or a rough surface that may later receive opaque material.

Various manufacturing techniques may be utilized to provide filters to the cover glass 15. In one embodiment, the identification marker 1 comprises a polarizing filter. The polarizing filter may be used to verify the authenticity of the camera view or video stream by illustrating how the polarization of reflections change when rotating the camera or the object. Examples of applicable filter types comprise absorptive filters, dichroic filters, monochromatic filters, infrared filters, ultraviolet filters, neutral density filters, long-pass filters, band-pass filters, short-pass filters, guided-mode resonance filters, metal mesh filters, polarizing filters or wedge filters.

In one exemplary embodiment the identification marker 1 is an optically variable device, OVD. The OVD is an iridescent or non-iridescent security feature that exhibits different information, such as movement or colour changes, depending on the viewing and/or lighting conditions. The particular changes of appearance when rotating and tilting are reversible, predictable and reproducible.

In one exemplary embodiment the identification marker 1 is a diffractive optically variable image device, DOVID. The DOVID is a type of optical variable device; a security feature based on visual effects created by diffraction. DOVIDs contain micro-or nanostructures in the form of diffractive gratings. Due to these structures, they exhibit optically variable effects such as dynamic chromatic, holographic, and kinematic effects, two-or three-dimensional images or color-changing effects, which ideally are easily recognized, but are difficult to reproduce. The DOVID can also contain elements which are invisible to the unaided human eye such as microprint, kinetic microtext, or a variable laser-readable micro-image that is invisible when magnified under white light. DOVID structures can be incorporated in a foil, which may then be hot stamped on the cover glass 15.

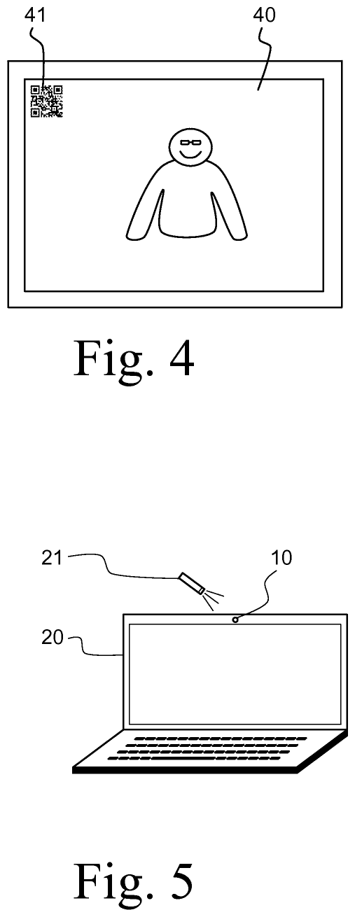

FIG. 4 illustrates schematically one exemplary view of a video stream captured by the camera 10 having an identification marker 1, as seen from the recipient of the video stream. The recipient's screen shows the video stream and the other party on the screen 40. In this example, the visual marking 41 is a QR code placed on the upper left corner of the screen. The recipient may verify the QR code 41 from the screen 40, as it may be used for a further security element that is linked to internet security framework. For example, the QR code may indicate via a trusted third party that the video stream originates from a trusted camera, which is known to be installed onto a trusted computer. The QR code may verify the hardware used by the other party.

FIG. 5 illustrates schematically one exemplary scenario of applying the identification marker 1 to the image captured by the camera 10. In this example, the camera 10 is installed to a laptop computer 20. The identification marker 1 may not be visible in the image captured by the image sensor 14 in all lighting conditions. In one embodiment, the user points a flashlight 21 or other bright light to enhance the visual marking by the identification marker 1. In one embodiment, a smartphone flashlight is used to illuminate the camera 10. The flashlight 21 may provide different colours to produce different visual effects to the visual marking. The flashlight 21 may be pointed from various directions to cause the visual marking to slightly move on the image sensor 14. The image sensor 14 comprises millions of pixels to detect light. Slight movements in the lighting causes different pixels to react to the identification marker 1. The movements of the flashlight 21 or any other light may be used to verify the identification marker 1, as such variations may be difficult to reproduce by software. Edges, slots or openings provide diffraction that may cause slight rainbow effects on small sections of the visual marking, visible only to few adjacent pixels.

Detecting the visual images or effects caused by the identification marker 1 is on one embodiment executed by a device comprising at least one processor and a memory storing instructions that, when executed, cause the device to compare the visual image to predefined rules, comparative images or other data to verify the authenticity.

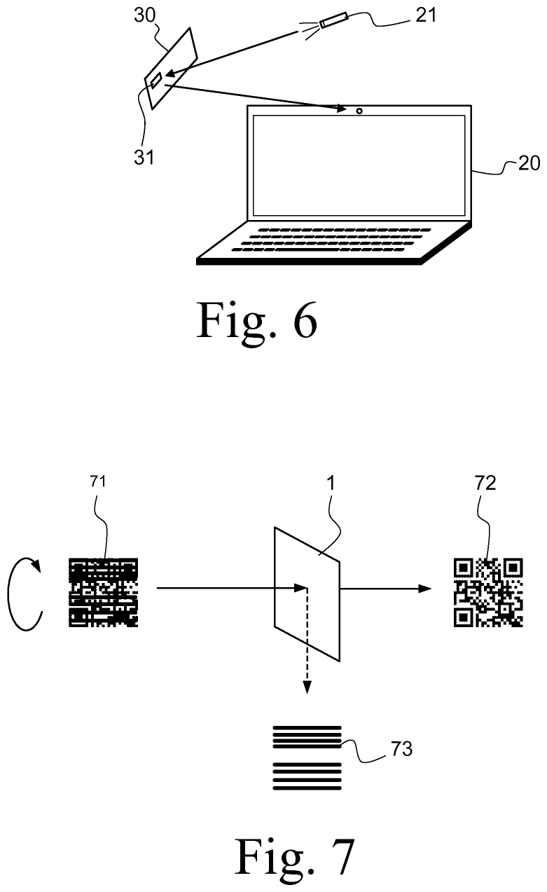

FIG. 6 illustrates schematically one exemplary scenario of a system for detecting an optical identity. The system comprises the camera 10 as described hereinbefore. An optical identity tag 31 is placed outside the camera 10 and configured to be captured by the camera 10. In this example, the optical identity tag 31 is placed on an object 31. The object may be a personal identity card, a passport or any device requiring to be verified. The object may be a quality product, a spare part or a luxury item. The optical identity tag 31 comprises a security hologram configured to reflect rays of light in a first predefined light pattern 71. FIG. 7 illustrates schematically one example of the first predefined light pattern 71. The first predetermined light pattern 71 may be reflected from the optical identity tag 31 by ambient light, backlight or it may be illuminated by the flashlight 21. The rays of light from the first predetermined light pattern travel to the camera 10 and to the identification marker 1. In this example, the identification marker 1 comprises the polarizing filter that blocks portion 73 from the first predetermined light pattern 71. The remaining rays of light that travel through the identification marker 1 produce a second predetermined light patter 72. The identification marker 1 is configured to alter the first predefined light pattern 71 into a second predefined light pattern 72. In this example, the second predetermined light pattern is the QR code that may be used for further security functions.

As the polarizing filter functions properly in only few orientations, the user may need to rotate the optical identity tag 31 to receive verification from the system. The optical identity tag 31 may comprise polarizing effect in multiple directions requiring a sequence of orientations. The user may visualize the placement of the optical identity tag 31 from a screen assisting in correct placement and orientation.

The identification marker 1 enables the camera 10 to be used as a security device reader for multiple security solutions. The camera 10 may be used to verify passports, identification cards or products. The camera 10 may provide additional security element to other visual and electronic security elements embedded in the tag. The security elements may be embedded in the product or device, or they may be installed by a security sticker. One example of the security sticker is a security hologram.

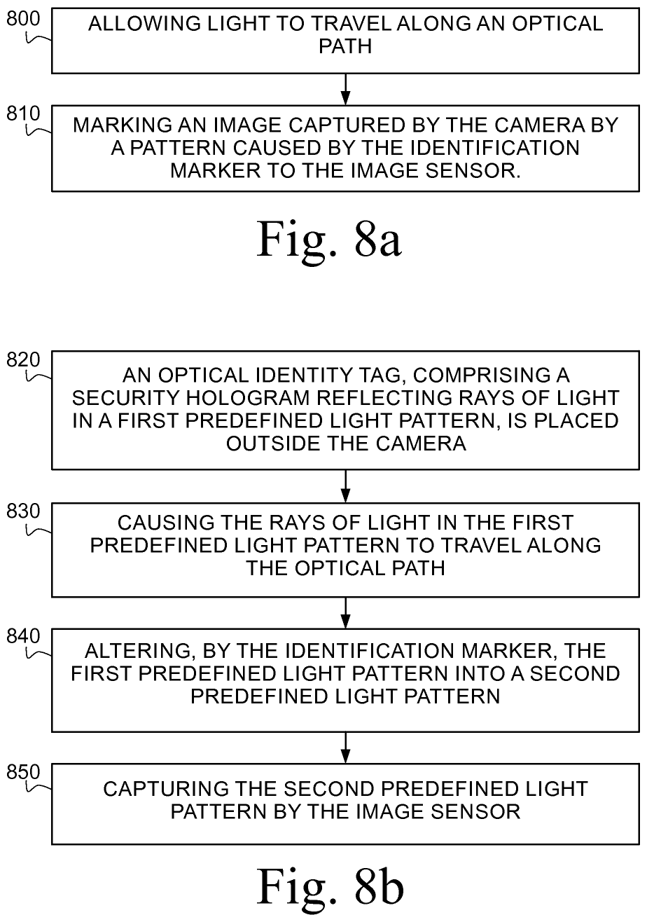

FIG. 8a illustrates a flowchart of one aspect of a method for identification. The method comprises a camera as described hereinbefore. The cover glass 15 comprises the identification marker 1 at the optical path blocking rays of light from reaching a portion of the image sensor 14. The method comprises the step of allowing light to travel along the optical path, block 800. Step 810 of the method comprises marking an image captured by the camera 10 by a pattern caused by the identification marker 1 to the image sensor 14.

FIG. 8b illustrates a flowchart of one aspect of a method for identification, wherein the identification marker is used to detect the optical identity tag 31. The steps may be considered to continue from the steps of FIG. 8a. The optical identity tag 31, comprising the security hologram reflecting rays of light in a first predefined light pattern 71, is placed outside the camera 10; step 820.

Step 830 comprises causing the rays of light in the first predefined light pattern 71 to travel along the optical path. In other words, the user may place the optical identity tag 31 to proper position for the camera to capture the image or the video. Step 840 comprises altering, by the identification marker 1, the first predefined light pattern 71 into a second predefined light pattern 72. Step 850 comprises capturing the second predefined light pattern 72 by the image sensor 14.

As one aspect, a camera is disclosed herein, comprising a lens; an image sensor receiving light from the lens; and a cover glass for the image sensor on an optical path between the lens and the image sensor. One aspect of this disclosure presents a novel cover glass, wherein the cover glass comprises an identification marker at the optical path, wherein the identification marker is configured to block rays of light to reach a portion of the image sensor. In one embodiment, the identification marker is configured to cast a shadow image of the identification marker to the image sensor. In one embodiment, the identification marker comprises a polarizing filter. In one embodiment, the identification marker comprises a grating configured to produce a spectra by diffraction to the image sensor. In one embodiment, the identification marker comprises a sticker attached to the cover glass. In one embodiment, the identification marker comprises a coating on a portion of the cover glass, wherein portions of the coating have been removed to provide the image of the identification marker. In one embodiment, the identification marker is printed on the cover glass. In one embodiment, the identification marker comprises an etching of the cover glass.

Alternatively, or in addition, a system for detecting an optical identity tag is disclosed. The system comprises a camera having a lens, an image sensor receiving light from the lens, and a cover glass for the image sensor on an optical path between the lens and the image sensor. An optical identity tag is placed outside the camera and configured to be captured by the camera. The optical identity tag comprises a security hologram configured to reflect rays of light in a first predefined light pattern; the cover glass comprises an identification marker at the optical path, wherein the identification marker is configured to block rays of light to reach a portion of the image sensor; and the identification marker is configured to alter the first predefined light pattern into a second predefined light pattern, when the first predefined light pattern is reflected from the optical identity tag to the identification marker. In one embodiment, the identification marker comprises a polarizing filter. In one embodiment, the identification marker comprises a grating configured to produce a spectra by diffraction to the image sensor. In one embodiment, the identification marker comprises a sticker attached to the cover glass. In one embodiment, the identification marker comprises a coating on a portion of the cover glass, wherein portions of the coating have been removed to provide the image of the identification marker. In one embodiment, the identification marker is printed on the cover glass. In one embodiment, the identification marker comprises an etching of the cover glass.

Alternatively, or in addition, a method for identification is disclosed for a camera-based system. The system comprises a camera having a lens, an image sensor receiving light from the lens; and a cover glass for the image sensor on the optical path between the lens and the image sensor. The cover glass comprises an identification marker at the optical path blocking rays of light from reaching a portion of the image sensor. The method comprises allowing light to travel along the optical path; and marking an image captured by the camera by a pattern caused by the identification marker to the image sensor. In one embodiment, the method comprises an optical identity tag, comprising a security hologram reflecting rays of light in a first predefined light pattern, is placed outside the camera, and the steps comprise causing the rays of light in the first predefined light pattern to travel along the optical path; and altering, by the identification marker, the first predefined light pattern into a second predefined light pattern; and capturing the second predefined light pattern by the image sensor.

Alternatively, or in addition, the functionality described herein can be performed, at least in part, by one or more hardware components or hardware logic components. An example of the device described hereinbefore is a computing-based device comprising one or more processors which may be microprocessors, controllers or any other suitable type of processors for processing computer-executable instructions to control the operation of the device in order to control one or more sensors, receive sensor data and use the sensor data. The computer-executable instructions may be provided using any computer-readable media that is accessible by a computing-based device. One example of the computing-based device is arranged in a cloud computing environment. Computer-readable media may include, for example, computer storage media such as memory and communications media. Computer storage media, such as memory, includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other memory technology, CD-ROM, digital versatile disks (DVD) or other optical storage, SSD drives, magnetic cassettes, magnetic tape, magnetic disk storage or other magnetic storage devices or any other non-transmission medium that can be used to store information for access by a computing device. In contrast, communication media may embody computer-readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The apparatus or the device may comprise an input/output controller arranged to output display information to a display device which may be separate from or integral to the apparatus or device. The input/output controller is also arranged to receive and process input from one or more devices, such as a user input device (a mouse, keyboard, camera, microphone or other sensor). Examples of the apparatus or the device are smartphones, laptops or tablet computers.

The methods described herein may be performed by a software in machine-readable form on a tangible storage medium in the form of a computer program comprising computer program code means adapted to perform all the steps of any of the methods described herein when the program is run on a computer and where the computer program may be embodied on a computer-readable medium. Examples of tangible storage media include computer storage devices comprising computer-readable media, such as disks, thumb drives, memory etc. and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Any range or device value given herein may be extended or altered without losing the effect sought.

Although at least a portion of the subject matter has been described in language specific to structural features and/or acts, it is to be understood that the subject matter defined in the accompanying claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or device may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A camera, comprising:
a lens;
an image sensor receiving light from the lens; and
a cover glass for the image sensor on an optical path between the lens and the image sensor;
wherein
the cover glass comprises an identification marker at the optical path, wherein the identification marker is configured to block rays of light to reach a portion of the image sensor.

2. A camera according to claim 1, wherein the identification marker is configured to cast a shadow image of the identification marker to the image sensor.

3. A camera according to claim 1 wherein the identification marker comprises a polarizing filter.

4. A camera according to claim 1, wherein the identification marker comprises a grating configured to produce a spectra by diffraction to the image sensor.

5. A camera according to claim 1, wherein the identification marker comprises a sticker attached to the cover glass or the identification marker is printed on the cover glass.

6. A camera according to claim 1, wherein the identification marker comprises a coating on a portion of the cover glass, wherein portions of the coating have been removed to provide the image of the identification marker.

7. A camera according to claim 1, wherein the identification marker comprises an etching of the cover glass.

8. A system for detecting an optical identity tag, comprising:
a camera, having a lens, an image sensor receiving light from the lens,
and a cover glass for the image sensor on an optical path between the lens and the image sensor; and
an optical identity tag placed outside the camera and configured to be captured by the camera,
wherein
the optical identity tag comprises a security hologram configured to reflect rays of light in a first predefined light pattern;
the cover glass comprises an identification marker at the optical path, wherein the identification marker is configured to block rays of light to reach a portion of the image sensor; and
the identification marker is configured to alter the first predefined light pattern into a second predefined light pattern, when the first predefined light pattern is reflected from the optical identity tag to the identification marker.

9. A system according to claim 8, wherein the identification marker comprises a polarizing filter.

10. A system according to claim 8, wherein the identification marker comprises a grating configured to produce a spectra by diffraction to the image sensor.

11. A system according to claim 8, wherein the identification marker comprises a sticker attached to the cover glass or the identification marker is printed on the cover glass.

12. A system according to claim 8, wherein the identification marker comprises a coating on a portion of the cover glass, wherein portions of the coating have been removed to provide the image of the identification marker.

13. A system according to claim 8, wherein the identification marker comprises an etching of the cover glass.

14. A method for identification, comprising:
a camera, having a lens, an image sensor receiving light from the lens;
and a cover glass for the image sensor on an optical path between the lens and the image sensor;
the cover glass comprises an identification marker at the optical path blocking rays of light from reaching a portion of the image sensor; and
the method comprises the steps of:
allowing light to travel along the optical path; and
marking an image captured by the camera by a pattern caused by the identification marker to the image sensor.

15. A method according to claim 14, wherein an optical identity tag, comprising a security hologram reflecting rays of light in a first predefined light pattern, is placed outside the camera;
causing the rays of light in the first predefined light pattern to travel along the optical path; and
altering, by the identification marker, the first predefined light pattern into a second predefined light pattern; and
capturing the second predefined light pattern by the image sensor.
